(19) United States
(12) Patent Application Publication
(10) Pub. No.: US 2017/0042083 A1
(43) Pub. Date: Feb. 16, 2017

(54) BAMBOO PLANTATIONS, FORESTS, AND STANDS AND METHODS OF STRIP OR ROW HARVESTING SAME

(71) Applicant: EcoPlanet Bamboo Group, Barrington, IL (US)

(72) Inventors: Camille REBELO, Nairobi (KE); Troy WISEMAN, Barrington Hills, IL (US)

(21) Appl. No.: 14/825,805

(22) Filed: Aug. 13, 2015

Related U.S. Application Data
(60) Provisional application No. 62/203,124, filed on Aug. 10, 2015.

(51) Int. Cl. A01C 21/00; A01G 23/00; A01G 23/08; A01G 7/00

(52) U.S. Cl. CPC A01C 21/005; A01G 7/00; A01G 23/00; A01G 23/08

(57) ABSTRACT

The invention is directed to a bamboo plantation where the bamboo is harvested in strips or in rows. In some aspects, the invention relates to methods of harvesting a bamboo plantation in strips or in rows. In some embodiments, the method and plantation described herein allows for sustainable mechanical harvesting of bamboo.

This application claims the benefit of U.S. Provisional Application No. 62/203,124, filed Aug. 10, 2015, the contents of which is hereby incorporated by reference in its entirety.

This patent disclosure contains material that is subject to copyright protection. The copyright owner has no objection to the facsimile reproduction by anyone of the patent document or the patent disclosure as it appears in the U.S. Patent and Trademark Office patent file or records, but otherwise reserves any and all copyright rights.

All publications, patent applications, patents, and other references mentioned herein are incorporated by reference in their entirety. The patent and scientific literature referred to herein establishes knowledge that is available to those skilled in the art. The issued patents, applications, and other publications that are cited herein are hereby incorporated by reference to the same extent as if each was specifically and individually indicated to be incorporated by reference. In the case of inconsistencies, the present disclosure will prevail.

### BACKGROUND

Bamboo fiber has the ability to transform the timber industry and reverse the current trend of global deforestation. Maximizing bamboo plant yield is critical for the industrialization of bamboo as a commercial crop. Bamboo has traditionally been grown as a crop in China, through a small holder farmer model, where each farmer grows a few hectares and harvests the bamboo at a low intensity. One of the limiting factors in the commercial production of bamboo and the utilization of natural bamboo forests is that the current harvesting methods are manually intensive as the bamboo is harvested by manual selective cutting of individual culms. Attempts to harvest bamboo plantations using complete clear cutting of large areas plantations have proved unsustainable, suggesting that mechanical harvesting of bamboo was not feasible.

There is a need for bamboo plantations and for methods of bamboo harvesting that allow for sustainable and commercial bamboo production.

### SUMMARY OF THE INVENTION

The invention relates to a bamboo plantation, bamboo forest, or bamboo stand where the bamboo is harvested in strips or in rows. In some aspects, the invention relates to methods of harvesting a bamboo plantation, bamboo forest, or bamboo stand in strips or in rows. In some embodiments, the methods and plantations described herein allows for sustainable mechanical harvesting of bamboo.

In certain aspects, the invention relates to a bamboo plantation, forest, or stand comprising monopodial bamboo plants, wherein bamboo culms within non-adjacent strips are harvested, wherein the non-adjacent strips are separated from each other by at least 2 strips and the strips are at least 1 meter wide.

In certain aspects, the invention relates to a method of harvesting monopodial bamboo plants, the method comprising harvesting bamboo culms from within non-adjacent strips wherein the non-adjacent strips are separated from each other by at least 2 strips and the strips are at least 1 meter wide. In some embodiments, the bamboo plants are growing in a bamboo plantation, forest, or stand.

In certain aspects, the invention related to a method of harvesting a monopodial bamboo plantation, forest, or stand, comprising: (a) dividing the monopodial bamboo plantation, forest, or stand into at least 1 meter wide strips; and (b) harvesting bamboo culms within non-adjacent strips, wherein the non-adjacent strips are separated from each other by at least 2 strips.

In some embodiments, the non-adjacent strips are separated from each other by at least 3 strips. In some embodiments, the non-adjacent strips are separated from each other by at least 4 strips. In some embodiments, the non-adjacent strips are separated from each other by 2 strips. In some embodiments, the non-adjacent strips are separated from each other by 3 strips. In some embodiments, the non-adjacent strips are separated from each other by 4 strips. In some embodiments, the strips are 1 meter to 10 meters wide. In some embodiments, the bamboo culms are harvested mechanically. In some embodiments, the bamboo culms are harvested non-mechanically. In some embodiments, the monopodial bamboo plant belongs to the genus Acidosasa sp., Arundinaria sp., Bashania sp., Chimonobambusa sp., Indocalamus sp., Pleioblastus sp., Phyllostachys sp., Sasa sp., Schizostachym sp., or Semiarundinaria sp. In some embodiments, the bamboo culms within non-adjacent strips are harvested once every 3 to 5 years. In some embodiments, the bamboo culms within non-adjacent strips are harvested once every 3 years. In some embodiments, the bamboo culms within non-adjacent strips are harvested once every 4 years. In some embodiments, the bamboo culms within non-adjacent strips are harvested once every 5 years. In some embodiments, all bamboo culms within the non-adjacent strips are harvested.

In certain aspects, the invention relates to a bamboo plantation, forest, or stand, comprising rows of sympodial bamboo plants, wherein bamboo clumps from non-adjacent rows are harvested, wherein the non-adjacent rows are separated from each other by at least 2 rows.

In certain aspects, the invention relates to a method of harvesting sympodial bamboo, the method comprising harvesting bamboo clumps from non-adjacent rows of sympodial bamboo plants, wherein the non-adjacent rows are separated from each other by at least 2 rows. In some embodiments, the bamboo plants are growing in a bamboo plantation, forest, or stand.

In some embodiments, the non-adjacent rows are separated from each other by at least 3 rows. In some embodiments, the non-adjacent rows are separated from each other by at least 4 rows. In some embodiments, the non-adjacent rows are separated from each other by 2 rows. In some embodiments, the non-adjacent strips are separated from each other by 3 rows. In some embodiments, the non-adjacent strips are separated from each other by 4 rows. In some embodiments, the bamboo culms are harvested mechanically. In some embodiments, the bamboo culms are harvested non-mechanically. In some embodiments, the sympodial bamboo plant belongs to the genus: Bambusa sp., Cephalostachym sp., Chusquea sp., Dendrocalamus sp., Dinochloa sp., Fargesia sp., Gigantochloa sp., Guadua sp., Melocalamus sp., Oxytenanthera sp., Schizostachyum sp., Thamnocalamus sp., Thyrostachys sp., or Yushania sp. In some embodiments, the sympodial bamboo plant is Bambusa vulgaris, Bambusa balcooa, Bambusa blumeana, Bambusa polymorpha, Bambusa textilis, Cephalostachyum pergracile, Dendrocalamus asper, Dendrocalamus barbatus, Dendrocalamus giganteus, Dendrocalamus membranaceus cv grandis, Dendrocalamus strictus, Dendrocalamus sinicus, Guadua aculeata, Guadua amplexifolia, Guadua angustifolia, or Oxytenanthera abyssinica. In some embodiments, bamboo clumps within non-adjacent rows are harvested once every 3 to 5 years. In some embodiments, bamboo clumps within non-adjacent rows are harvested once every 3 years. In some embodiments, bamboo clumps within non-adjacent rows are harvested once every 4 years. In some embodiments, bamboo clumps within non-adjacent rows are harvested once every 5 years.

In certain aspects, the invention relates to a bamboo plantation, forest, or stand comprising rows of sympodial bamboo plants, wherein bamboo clumps from non-adjacent strips of rows are harvested, wherein the non-adjacent strips are separated from each other by at least 2 strips and the strips are at least 1 to no more than 10 meters wide; and wherein the rows of sympodial bamboo plants are spaced at least 1 meter to no more than 10 meters apart.

In certain aspects, the invention related to a method of harvesting a sympodial bamboo plantation, forest, or stand, comprising: (a) dividing the sympodial bamboo plantation, forest, or stand into at least 1 meter wide strips; and (b) harvesting bamboo clumps within non-adjacent strips, wherein the non-adjacent strips are separated from each other by at least 2 strips.

In some embodiments, the non-adjacent strips are separated from each other by at least 3 strips. In some embodiments, the non-adjacent strips are separated from each other by at least 4 strips. In some embodiments, the non-adjacent strips are separated from each other by 2 strips. In some embodiments, the non-adjacent strips are separated from each other by 3 strips. In some embodiments, the non-adjacent strips are separated from each other by 4 strips. In some embodiments, the bamboo clumps are harvested mechanically. In some embodiments, the bamboo clumps are harvested non-mechanically. In some embodiments, the sympodial bamboo plant belongs to the genus: Bambusa sp., Cephalostachym sp., Chusquea sp., Dendrocalamus sp., Dinochloa sp., Fargesia sp., Gigantochloa sp., Guadua sp., Melocalamus sp., Oxytenanthera sp., Schizostachyum sp., Thamnocalamus sp., Thyrostachys sp., or Yushania sp. In some embodiments, the sympodial bamboo plant is Bambusa vulgaris, Bambusa balcooa, Bambusa blumeana, Bambusa polymorpha, Bambusa textilis, Cephalostachyum pergracile, Dendrocalamus asper, Dendrocalamus barbatus, Dendrocalamus giganteus, Dendrocalamus membranaceus cv grandis, Dendrocalamus strictus, Dendrocalamus sinicus, Guadua aculeata, Guadua amplexifolia, Guadua angustifolia, or Oxytenanthera abyssinica. In some embodiments, bamboo clumps within non-adjacent rows are harvested once every 3 to 5 years. In some embodiments, bamboo clumps within non-adjacent rows are harvested once every 3 years. In some embodiments, bamboo clumps within non-adjacent rows are harvested once every 4 years. In some embodiments, bamboo clumps within non-adjacent rows are harvested once every 5 years.

### BRIEF DESCRIPTION OF THE DRAWINGS

The patent or application file contains at least one drawing or photograph executed in color. Copies of this patent or patent application publication with color drawing(s) will be provided by the United States Patent and Trademark Office upon request and payment of the necessary fee.

FIG. 1 shows an embodiment of a monopodial bamboo plantation comprising repeating sets of three strips of bamboo plants. The strips are at least 1 meter wide and no more than 10 meters wide.

FIG. 2 shows an embodiment of a monopodial bamboo plantation comprising repeating sets of 3 strips. Non-adjacent strips are separated from each other by 2 strips and the bamboo culms within non-adjacent strips are harvested once every 3 years. The year in which the bamboo culms within each strip are to be harvested is shown.

FIG. 3 shows an embodiment of a monopodial bamboo plantation comprising repeating sets of 4 strips. Non-adjacent strips are separated from each other by 3 strips and the bamboo culms within non-adjacent strips are harvested once every 4 years. The year in which the bamboo culms within each strip are to be harvested is shown.

FIG. 4 shows an embodiment of a monopodial bamboo plantation comprising repeating sets of 5 strips. Non-adjacent strips are separated from each other by 4 strips and the bamboo culms within non-adjacent strips are harvested once every 5 years. The year in which the bamboo culms within each strip are to be harvested is shown.

FIG. 5 shows an embodiment of a sympodial bamboo plantation comprising rows of plants. The bamboo clumps within non-adjacent rows are harvested once every 3 years. FIG. 5 shows harvested non-adjacent rows separated from each other by 2 non-harvested rows. The year in which the bamboo clumps within each row are to be harvested is shown.

FIG. 6 shows an embodiment of a sympodial bamboo plantation comprising rows of plants. The bamboo clumps within non-adjacent rows are harvested once every 4 years. FIG. 6 shows harvested non-adjacent rows separated from each other by 3 rows.

FIG. 7 shows an embodiment of a sympodial bamboo plantation comprising rows of plants. The bamboo clumps within non-adjacent rows are harvested once every 5 years. FIG. 7 shows harvested non-adjacent rows separated from each other by 4 rows.

FIG. 8 shows a mature monopodial bamboo plantation in China where the monopodial bamboo has been divided into 3 meter wide strips, and wherein a 3 meter wide strip has undergone strip harvesting. All culms within this strip have been harvested.

FIG. 9 shows the mature monopodial bamboo plantation in China where the harvested 3 meter wide strip from FIG. 8 has undergone a year of regrowth and at a time where a non-adjacent 3 meter wide strip will be harvested.

FIG. 10 shows a mature monopodial bamboo plantation in China where the monopodial bamboo has been divided into strips of 6 meters wide, and wherein a 6 meter wide strip has undergone strip harvesting. All culms within this strip have been harvested.

FIG. 11 shows a mature monopodial bamboo plantation in China where the monopodial bamboo has been divided into strips of 9 meters wide, and wherein a 9 meter wide strip has undergone strip harvesting. All culms within this strip have been harvested.

### DETAILED DESCRIPTION

The singular forms “a,” “an,” and “the” include plural reference unless the context clearly dictates otherwise.

The term “about” is used herein to mean approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 20%.

The invention relates to a bamboo plantation where the bamboo is harvested in strips or in rows. In some aspects, the invention relates to methods of harvesting a bamboo plantation in strips or in rows. In some embodiments, the method and plantation described herein allows for sustainable mechanical harvesting of bamboo.

Bamboo as a Sustainable Fiber

Bamboo fiber has the ability to transform the timber industry and reverse the current trend of global deforestation. Bamboo fiber, woven, or in laminated form, can be used for plywood, composites and veneers. With a relatively long fiber length its pulp can also be used for a range of paper products, from sanitary paper, to copy paper to packaging. It can also be fed into the dissolving pulp industry with little change to machinery, and be used to replace cellulosic pulp with a yarn that exhibits a range of superior properties. Bamboo also has a calorific value equivalent to most woods, allowing it to provide renewable and distributed energy across all levels of processing, from simple charcoal to gasification.

Bamboo's advantages are multidimensional but focus around the grass's ability to produce high volumes of fiber per unit area, even when grown on degraded land. Furthermore, bamboo fiber can be substituted in a diverse range of products, including, but not limited to paper, plywood, MDF board, textiles, and bioenergy.

Ecologically, bamboo has many unique attributes that enable it to have the potential to be one of the most sustainable sources of fiber or biomass on the planet. Bamboo can reverse land degradation, restore canopy cover and maintain soil productivity, water tables and carbon cycles.

One of the limiting factors in the commercial production of bamboo is that the current harvesting methods are costly due to being manually intensive, as the bamboo is harvested by manual selective cutting of individual culms. Attempts to harvest bamboo plantations using clear cutting of individual plants or large areas of plantations have proved unsustainable, suggesting that mechanical harvesting of bamboo was not feasible. Described herein, is a method of harvesting bamboo that enables bamboo to be an economically viable crop.

Bamboo

Bamboo is a plant in the grass family Poaceae. Individual bamboo shoots emerge from the ground and grow to their full height in a single growing season. During the growing season, each new shoot grows vertically into a culm. Branching out does not occur until the majority of the mature height is reached, then branches can extend from nodes and leafing out occurs. Over time the pulpy wall of each culm slowly hardens into a fully mature culm.

Some bamboo species exhibit a monopodial growth pattern. Monopodial bamboo species are also called running bamboos. Modopodial bamboo species have a underground root and rhizome system that spreads laterally. Individual plants merge into each other with no above ground distinction of where a single plant ends and the next plant begins. Individual culms emerge from the ground at random.

In some embodiments, the monopodial bamboo plant belongs to the genus Acidosasa sp., Arundinaria sp., Bashania sp., Chimonobambusa sp., Indocalamus sp., Pleioblastus sp., Phyllostachys sp., Sasa sp., Schizostachym sp., or Semiarundinaria sp.

Some bamboo species exhibit a sympodial growth pattern. Sympodial bamboo species are also called clumping bamboos. Sympodial bamboo species have a underground root and rhizome system maintained within a relatively compact area. New culms emerge from this central system without significant lateral spread, and each bamboo plant or clump grows in an area that can be distinguished from a neighboring plant or clump.

In one embodiment, sympodial bamboo species belong to the genus Bambusa sp., Cephalostachym sp., Chusquea sp., Dendrocalamus sp., Dinochloa sp., Fargesia sp., Gigantochloa sp., Guadua sp., Melocalamus sp., Oxytenanthera sp., Schizostachyum sp., Thamnocalamus sp., Thyrostachys sp., or Yushania sp. In some embodiments, the sympodial bamboo is Bambusa vulgaris, Bambusa balcooa, Bambusa blumeana, Bambusa polymorpha, Bambusa textilis, Cephalostachyum pergracile, Dendrocalamus asper, Dendrocalamus barbatus, Dendrocalamus giganteus, Dendrocalamus membranaceus cv grandis, Dendrocalamus strictus, Dendrocalamus sinicus, Guadua aculeata, Guadua amplexifolia, Guadua angustifolia, or Oxytenanthera abyssinica. In certain aspects, the invention relates to a bamboo plantation or to a naturally occurring bamboo forest, or bamboo stand. Naturally occurring bamboo forests or stands, and bamboo plantations can comprise native or naturalized species of bamboo. The availability of a native species of high commercial value is a factor taken into consideration for a bamboo plantation. Where no suitable native species occurs, bamboo species can be selected by their ability to meet the goals of the proposed project and area.

As with trees, each species of bamboo is unique, and has properties suitable for specific end uses. Sugar content, silica content, wall thickness, fiber length, fiber density can vary between bamboo species.

Bamboo requires 5 to 7 years to reach maturity. In some embodiments, the bamboo plants of the invention should be grown for at least 5 years prior to the first harvest. In some embodiments, the bamboo plantation, bamboo forest, or bamboo stand of the invention should be at least 5 years old.

Bamboo Plantations, Bamboo Forests, and Bamboo Stands and Methods of Harvesting Same

Commercial production of bamboo can depend on maximizing yield and mechanizing harvesting methods. One advantage of bamboo is that once a bamboo plant is mature harvesting the plant in the correct manner can stimulate rapid regrowth without requiring any replanting. This results in high yields of biomass per unit area of land. However, typically bamboo farming is manually intensive and therefore costly as it requires selective cutting of individual culms from a plant. Attempts to harvest bamboo by mechanical non-selective clear cutting have failed and the long term yield of the bamboo plantation, bamboo forest, or bamboo stand is not sustained. Without being bound by theory, the failure of clear cutting is due to the fact that there is no leafy material left. This leafy material is required for photosynthesis and the production of energy for the plant. Once the leafy material is removed, the plant must rely on its underground reserves, which is not sustainable over time.

Described herein is a bamboo plantation, bamboo forest, or bamboo stand that significantly reduces harvesting costs, while maintaining annual productivity, high and sustained yields, as well as the ecosystem and environmental benefits of bamboo.

Also, described herein is a method of harvesting bamboo that significantly reduces harvesting costs, while maintaining annual productivity, high and sustained yields and the ecosystem and environmental benefits of bamboo.

In certain aspects, the method of harvesting described herein can be used to harvest commercial bamboo plantations, or naturally occurring bamboo forests and stands. In some embodiments, the harvested bamboo is used for the production of a high yielding fiber for the pulp and paper industry.

Monopodial Bamboo Plantations, Bamboo Forests, and Bamboo Stands and Methods of Harvesting Same

In certain aspects, the invention relates to strip harvesting of monopodial bamboo culms. As described herein, strip harvesting allows the underground root system of the plant to remain intact and maintains sufficient leafy material for the plant to continue to produce sufficient food for continued uninhibited growth. The harvesting described herein allows for the clearing of all bamboo culms within a certain strip. Completely clearing a linear strip of bamboo allows for ease of removal of harvested material from the planted area. In some embodiments, the bamboo culms are manually harvested. In some embodiments, the bamboo culms are mechanically harvested.

In certain aspects, the invention relates to a bamboo plantation, bamboo forest, or bamboo stand, comprising monopodial bamboo plants, wherein bamboo culms within non-adjacent strips are harvested, wherein the non-adjacent strips are separated from each other by at least 2 strips and the strips are at least 1 meter wide.

In certain aspects, the invention provides a method of harvesting monopodial bamboo plants, the method comprising harvesting bamboo culms from within non-adjacent strips wherein the non-adjacent strips are separated from each other by at least 2 strips and the strips are at least 1 meter wide. In some embodiments, the bamboo plants are growing in a bamboo plantation. In another embodiment, the bamboo plants are growing in a naturally occurring bamboo forest or bamboo stand.

In certain aspects, the invention provides a method of harvesting a monopodial bamboo plantation, forest, or stand comprising: (a) dividing the monopodial bamboo plantation, forest, or stand into at least 1 meter wide strips; and (b) harvesting bamboo culms within non-adjacent strips, wherein the non-adjacent strips are separated from each other by at least 2 strips.

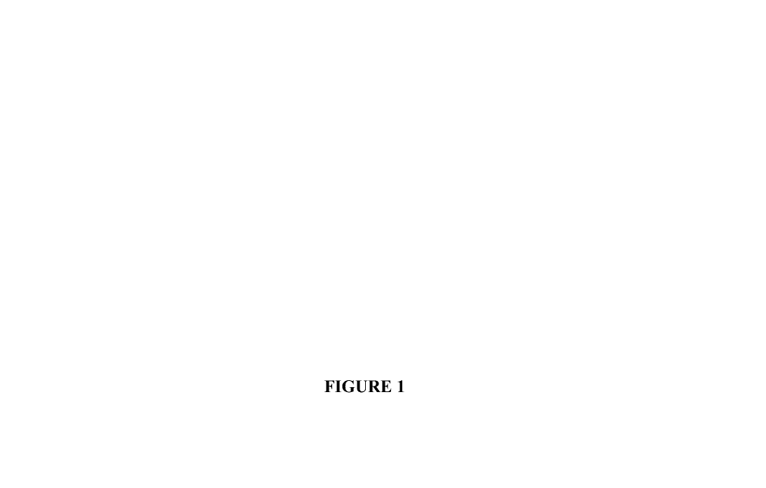

In some embodiments, the non-adjacent strips are separated from each other by at least 3 strips. In some embodiments, the non-adjacent strips are separated from each other by at least 4 strips. In some embodiments, the non-adjacent strips are separated from each other by 2 strips. In some embodiments, the non-adjacent strips are separated from each other by 3 strips. In some embodiments, the non-adjacent strips are separated from each other by 4 strips. FIG. 1 shows an embodiment of a monopodial bamboo plantation, each embodiment comprising repeating sets of three strips of bamboo plants.

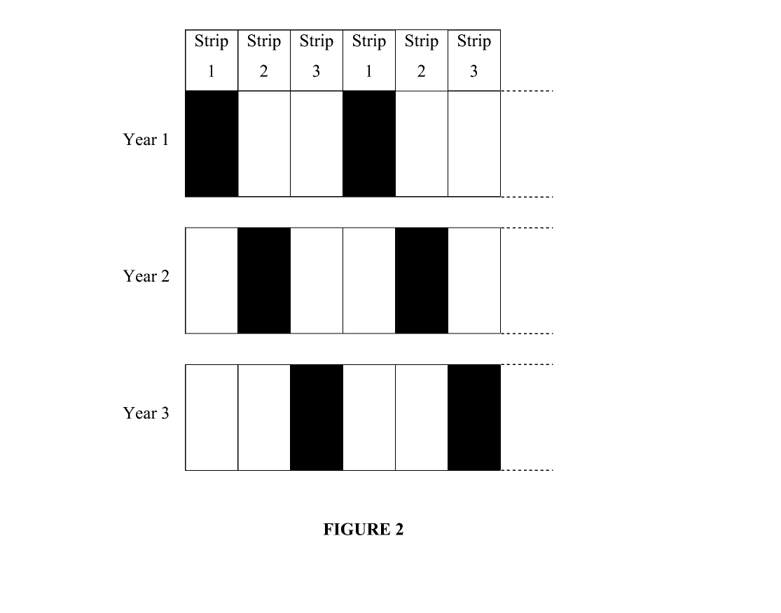

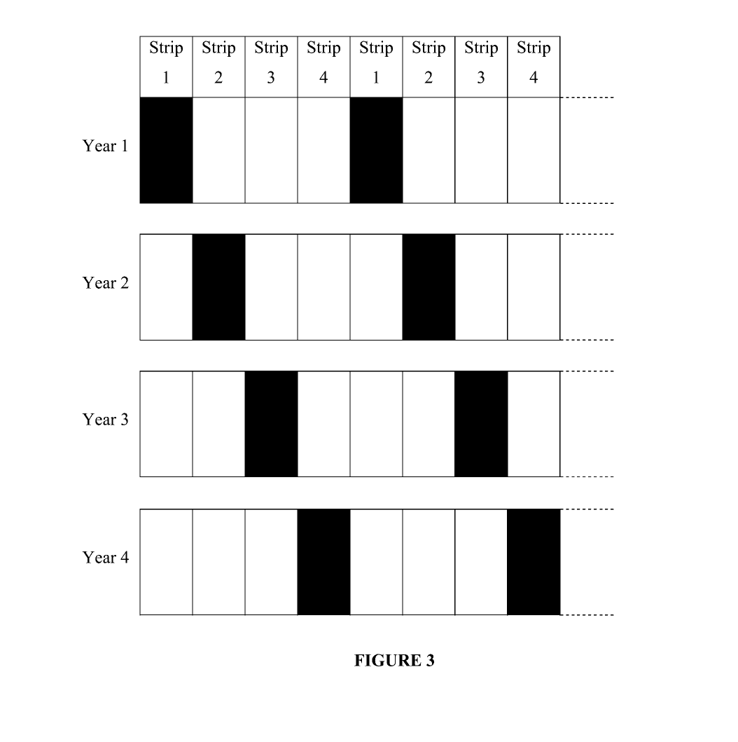

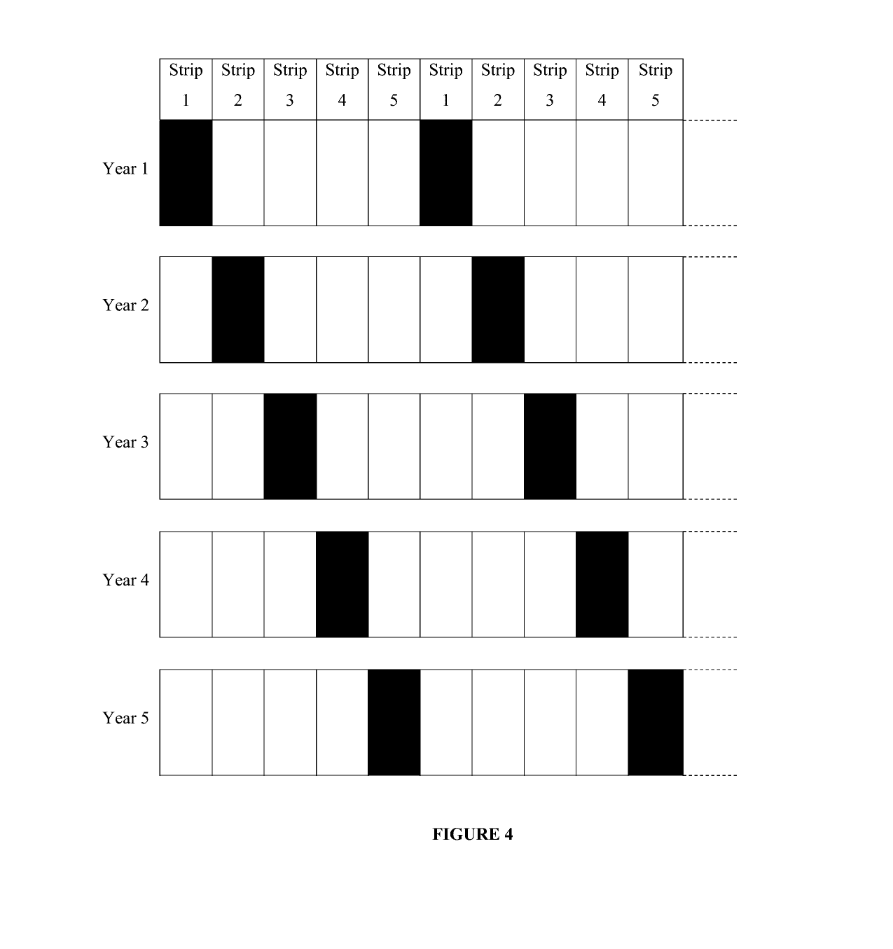

In some embodiments, the bamboo culms within non-adjacent strips are harvested once every 3 to 5 years. Therefore, in some embodiments, one third to one fifth of the plantation, forest, or stand is harvested every year. In some embodiments, the bamboo culms within non-adjacent strips are harvested once every 3 years. In some embodiments, the bamboo culms within non-adjacent strips are harvested once every 4 years. In some embodiments, the bamboo culms within non-adjacent strips are harvested once every 5 years. FIGS. 2-4 shows different embodiments of a monopodial bamboo plantation, forest, or stand.

The strip harvesting described herein, can be used to harvest the bamboo culms of a bamboo plantation or to harvest bamboo culms of a naturally occurring bamboo forest, or bamboo stand. Bamboo plantations, or naturally occurring bamboo forests or stands can be marked or divided into strips and harvested as described herein.

In some embodiments, the non-adjacent strips are separated from each other by 2 strips and the bamboo culms within non-adjacent strips are harvested once every 3 years. In some embodiments, every third strip is harvested on a 3 year cycle. For example, a first set of strips separated from each other by 2 strips are harvested in year 1. In year 2, a second set of strips separated from each other by 2 strips are harvested. In year 3, a third set of strips separated from each other by 2 strips are harvested. In some embodiments, the second set of strips are adjacent to the first set of strips and the third set of strips. In some embodiments, the third set of strips are adjacent to the first set of strips and the second set of strips. In some embodiments, the strips are harvested every 3 years. For example, after year 3, the first set of strips are harvested again in year 4, the second set of strips are harvested again in year 5, and the third set of strips are harvested again in year 6. In some embodiments, the strips can be harvested on a cycle longer than 3 years, therefore, there may be years when no strips are harvested.

In some embodiments, the non-adjacent strips are separated from each other by 3 strips and the bamboo culms within non-adjacent strips are harvested once every 4 years. In some embodiments, every fourth strip is harvested on a 4 year cycle. For example, a first set of strips separated from each other by 3 strips are harvested in year 1. In year 2, a second set of strips separated from each other by 3 strips are harvested. In year 3, a third set of strips separated from each other by 3 strips are harvested. In year 4, a fourth set of strips separated from each other by 3 strips are harvested. In some embodiments, the harvested strips are not adjacent to a strip that was harvested in the previous year. In other embodiments, the harvested strips are adjacent to a strip that was harvested in the previous year. In some embodiments, the strips are harvested every 4 years. For example, after year 4, the first set of strips are harvested again in year 5, the second set of strips are harvested again in year 6, the third set of strips are harvested again in year 7, and the fourth set of strips are harvested again in year 8. In some embodiments, the strips can be harvested on a cycle longer than 4 years, therefore, there may be years when no strips are harvested.

In some embodiments, the non-adjacent strips are separated from each other by 4 strips and the bamboo culms within non-adjacent strips are harvested once every 5 years. In some embodiments, every fifth strip is harvested on a 5 year cycle. For example, a first set of strips separated from each other by 4 strips are harvested in year 1. In year 2, a second set of strips separated from each other by 4 strips are harvested. In year 3, a third set of strips separated from each other by 4 strips are harvested. In year 4, a fourth set of strips separated from each other by 4 strips are harvested. In year 5, a fifth set of strips separated from each other by 4 strips are harvested. In some embodiments, the harvested strips are not adjacent to a strip that was harvested in the previous year. In other embodiments, the harvested strips are adjacent to a strip that was harvested in the previous year. In some embodiments, the strips are harvested every 5 years. For example, after year 5, the first set of strips are harvested again in year 6, the second set of strips are harvested again in year 7, the third set of strips are harvested again in year 8, the fourth set of strips are harvested again in year 9, and the fifth set of strips are harvested again in year 10. In some embodiments, the strips can be harvested on a cycle longer than 5 years, therefore, there may be years when no strips are harvested.

In some embodiments, the bamboo plantation, bamboo forest, or bamboo stand comprises at least 3 strips. In some embodiments, the bamboo plantation, bamboo forest, or bamboo stand comprises at least 4 strips. In some embodiments, the bamboo plantation, bamboo forest, or bamboo stand comprises at least 5 strips.

In some embodiments, the strips are at least 1 meter wide. In some embodiments, the strips are at least 2 meters wide. In some embodiments, the strips are at least 3 meters wide. In some embodiments, the strips are at least 4 meters wide. In some embodiments, the strips are at least 5 meters wide. In some embodiments, the strips are at least 6 meters wide. In some embodiments, the strips are at least 7 meters wide. In some embodiments, the strips are at least 8 meters wide. In some embodiments, the strips are at least 9 meters wide. In some embodiments, the strips are no more than 10 meters wide. In some embodiments, all the strips are the same width. In some embodiments, the strips are different widths.

In some embodiments, the strips are 1 meter to 10 meters wide. In some embodiments, the strips are about 1 meter wide. In some embodiments, the strips are about 2 meters wide. In some embodiments, the strips are about 3 meters wide. In some embodiments, the strips are about 4 meters wide. In some embodiments, the strips are about 5 meters wide. In some embodiments, the strips are about 6 meters wide. In some embodiments, the strips are about 7 meters wide. In some embodiments, the strips are about 8 meters wide. In some embodiments, the strips are about 9 meters wide. In some embodiments, the strips are about 10 meters wide.

In some embodiments, the monopodial bamboo plants are planted or are growing at a density of at least 150 plants per hectare. In some embodiments, the monopodial bamboo plants are planted or are growing at a density of at least 250 plants per hectare. In some embodiments, the monopodial bamboo plants are planted or are growing at a density of at least 350 plants per hectare. In some embodiments, the monopodial bamboo plants are planted or are growing at a density of at least 450 plants per hectare. In some embodiments, the monopodial bamboo plants are planted or are growing at a density of at least 550 plants per hectare. In some embodiments, the monopodial bamboo plants are planted or are growing at a density of at least 650 plants per hectare. In some embodiments, the monopodial bamboo plants are planted or are growing at a density of at least 750 plants per hectare. In some embodiments, the monopodial bamboo plants are planted or are growing at a density of at least 850 plants per hectare. In some embodiments, the monopodial bamboo plants are planted or are growing at a density of at least 950 plants per hectare. In some embodiments, the monopodial bamboo plants are planted or are growing at a density of at least 1000 plants per hectare.

In some embodiments, the monopodial bamboo plants are planted or are growing at a density of about 150 plants per hectare. In some embodiments, the monopodial bamboo plants are planted or are growing at a density of about 250 plants per hectare. In some embodiments, the monopodial bamboo plants are planted or are growing at a density of about 350 plants per hectare. In some embodiments, the monopodial bamboo plants are planted or are growing at a density of about 450 plants per hectare. In some embodiments, the monopodial bamboo plants are planted or are growing at a density of about 550 plants per hectare. In some embodiments, the monopodial bamboo plants are planted or are growing at a density of about 650 plants per hectare. In some embodiments, the monopodial bamboo plants are planted or are growing at a density of about 750 plants per hectare. In some embodiments, the monopodial bamboo plants are planted or are growing at a density of about 850 plants per hectare. In some embodiments, the monopodial bamboo plants are planted or are growing at a density of about 950 plants per hectare. In some embodiments, the monopodial bamboo plants are planted or are growing at a density of about 1000 plants per hectare.

In some embodiments, the monopodial bamboo plant belongs to the genus Acidosasa sp., Arundinaria sp., Bashania sp., Chimonobambusa sp., Indocalamus sp., Pleioblastus sp., Phyllostachys sp., Sasa sp., Schizostachym sp., or Semiarundinaria sp.

In some embodiments, bamboo culms of the plantation, forest, or stand are harvested mechanically. For example, the bamboo culms can be harvested with a chain saw. Bamboo can also be cut mechanically with a bamboo cutting machine that cuts the plant at the base of the culm and loads the cut bamboo onto a carrier. In some embodiments, bamboo culms of the plantation, forest, or stand are harvested non-mechanically. For example, the bamboo culms are harvested with a machete or a bush knife between the first and second node from the ground. In some embodiments, all bamboo culms within the non-adjacent strips are harvested.

In certain aspects, the invention relates to a bamboo plantation grown from tissue culture plantlets, vegetative propagation, or from seed. In some embodiments, the bamboo plants are planted from seed, tissue culture plantlets or by vegetative means.

In some embodiments, the plantation, forest, or stand is farmed using conventional methods. In some embodiments, the bamboo plants are farmed using conventional methods, including but not limited to fertilization, weeding and pest control. In some embodiments, the bamboo plants are treated with fertilizer. In some embodiments, the bamboo plants are not treated with fertilizer.

Sympodial Bamboo Plantations, Bamboo Forests, and Bamboo Stands and Methods of Harvesting Same

In certain aspects, the invention relates to strip harvesting of sympodial bamboo clumps. As described herein, strip harvesting allows the underground root system of the plant to remain intact and maintains sufficient leafy material for the plant to continue to produce sufficient food for continued uninhibited growth. The harvesting described herein allows for the clearing of all bamboo culms within a certain row or rows of sympodial bamboo plants.

In certain aspects, the invention relates to harvesting of non-adjacent rows of sympodial bamboo plants. In some embodiments, the rows are harvested on a 3 to 5 year rotation. As described herein, the harvesting of non-adjacent rows maintains a sufficient ecosystem that the harvested plants can rely on underground reserves for regrowth. Furthermore, the harvested plants are supported by the surrounding non-harvested bamboo plants due to maintenance of water tables, nutrient replenishment, and soil protection.

In certain aspects, the inventions relates to a bamboo plantation, bamboo forest, or bamboo stand comprising rows of sympodial bamboo plants, wherein bamboo clumps from non-adjacent rows are harvested, wherein the non-adjacent rows are separated from each other by at least 2 rows.

In certain aspects, the invention provides a method of harvesting sympodial bamboo, the method comprising harvesting bamboo clumps from non-adjacent rows of sympodial bamboo plants, wherein the non-adjacent rows are separated from each other by at least 2 rows. In some embodiments, the bamboo plants are growing in a bamboo plantation. In another embodiment, the bamboo plants are growing in a naturally occurring bamboo forest or bamboo stand.

In some embodiments, the non-adjacent rows are separated from each other by at least 3 rows. In some embodiments, the non-adjacent rows are separated from each other by at least 4 rows. In some embodiments, the non-adjacent rows are separated from each other by 2 rows. In some embodiments, the non-adjacent rows are separated from each other by 3 rows. In some embodiments, the non-adjacent rows are separated from each other by 4 rows.

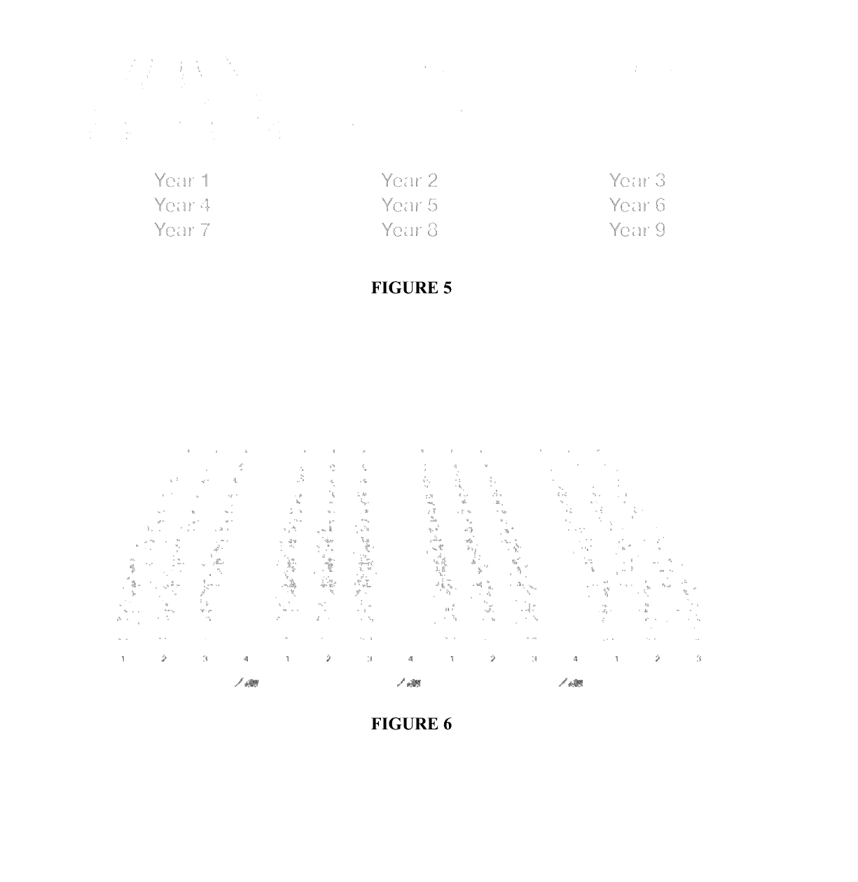

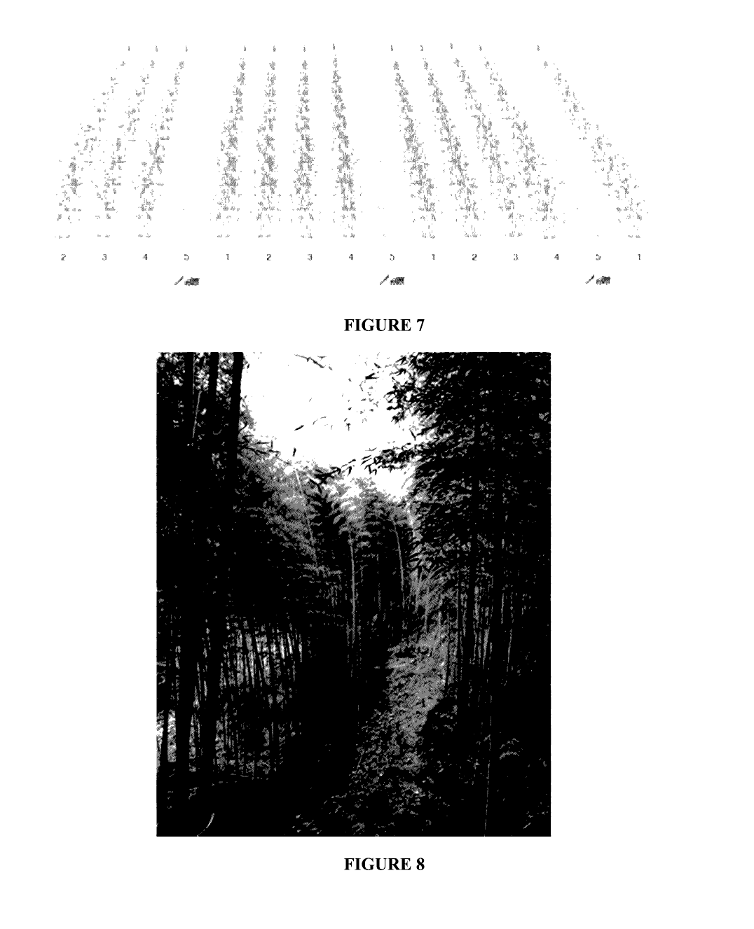

In some embodiments, the bamboo clumps within non-adjacent rows are harvested once every 3 to 5 years. Therefore, in some embodiments, one third to one fifth of the plantation, forest, or stand is harvested every year. In some embodiments, the bamboo clumps within non-adjacent rows are harvested once every 3 years. In some embodiments, the bamboo clumps within non-adjacent rows are harvested once every 4 years. In some embodiments, the bamboo clumps within non-adjacent rows are harvested once every 5 years. FIGS. 5-7 show different embodiments of a sympodial bamboo plantation, forest, or stand.

In some embodiments, the non-adjacent rows are separated from each other by 2 rows and the bamboo clumps within non-adjacent rows are harvested once every 3 years. In some embodiments, every third row of sympodial bamboo plants is harvested on a 3 year cycle. For example, a first set of rows separated from each other by 2 rows are harvested in year 1. In year 2, a second set of rows separated from each other by 2 rows are harvested. In year 3, a third set of rows separated from each other by 2 rows are harvested. In some embodiments, the second set of rows are adjacent to the first set of rows and the third set of rows. In some embodiments, the third set of rows are adjacent to the first set of rows and the second set of rows. In some embodiments, the rows are harvested every 3 years. For example, after year 3, the first set of rows are harvested again in year 4, the second set of rows are harvested again in year 5, and the third set of rows are harvested again in year 6. In some embodiments, the rows can be harvested on a cycle longer than 3 years, therefore, there may be years when no rows are harvested.

In some embodiments, the non-adjacent rows are separated from each other by 3 rows and the bamboo clumps within non-adjacent rows are harvested once every 4 years. In some embodiments, every fourth strip of sympodial bamboo plants is harvested on a 4 year cycle. For example, a first set of rows separated from each other by 3 rows are harvested in year 1. In year 2, a second set of rows separated from each other by 3 rows are harvested. In year 3, a third set of rows separated from each other by 3 rows are harvested. In year 4, a fourth set of rows separated from each other by 3 rows are harvested. In some embodiments, the harvested rows are not adjacent to a row that was harvested in the previous year. In other embodiments, the harvested rows are adjacent to a row that was harvested in the previous year. In some embodiments, the rows are harvested every 4 years. For example, after year 4, the first set of rows are harvested again in year 5, the second set of rows are harvested again in year 6, the third set of rows are harvested again in year 7, and the fourth set of rows are harvested again in year 8. In some embodiments, the rows can be harvested on a cycle longer than 4 years, therefore, there may be years when no rows are harvested.

In some embodiments, the non-adjacent rows are separated from each other by 4 rows and the bamboo clumps within non-adjacent rows are harvested once every 5 years. In some embodiments, every fifth strip of sympodial bamboo plants is harvested on a 5 year cycle. For example, a first set of rows separated from each other by 4 rows are harvested in year 1. In year 2, a second set of rows separated from each other by 4 rows are harvested. In year 3, a third set of rows separated from each other by 4 rows are harvested. In year 4, a fourth set of rows separated from each other by 4 rows are harvested. In year 5, a fifth set of rows separated from each other by 4 rows are harvested. In some embodiments, the harvested rows are not adjacent to a row that was harvested in the previous year. In other embodiments, the harvested rows are adjacent to a row that was harvested in the previous year. In some embodiments, the rows are harvested every 5 years. For example, after year 5, the first set of rows are harvested again in year 6, the second set of rows are harvested again in year 7, the third set of rows are harvested again in year 8, the fourth set of rows are harvested again in year 9, and the fifth set of rows are harvested again in year 10. In some embodiments, the rows can be harvested on a cycle longer than 5 years, therefore, there may be years when no rows are harvested.

In some embodiments, the bamboo plantation, bamboo forest, or bamboo stand comprises at least 3 rows of sympodial bamboo plants. In some embodiments, the bamboo plantation, bamboo forest, or bamboo stand comprises at least 4 rows of sympodial bamboo plants. In some embodiments, the bamboo plantation, bamboo forest, or bamboo stand comprises at least 5 rows of sympodial bamboo plants.

In some embodiments, the rows comprise sympodial bamboo plants planted or growing in a regularly spaced pattern. In some embodiments, the rows of sympodial bamboo plants are planted or grow parallel to each other. In some embodiments, the rows of sympodial bamboo plants are spaced 1 meter to 10 meters apart. In some embodiments, the rows of sympodial bamboo plants are spaced at least 1 meter apart. In some embodiments, the rows of sympodial bamboo plants are spaced at least 2 meters apart. In some embodiments, the rows of sympodial bamboo plants are spaced from 2 to 8 meters apart. In some embodiments, the rows of sympodial bamboo plants are spaced at least 3 meters apart. In some embodiments, the rows of sympodial bamboo plants are spaced at least 4 meters apart. In some embodiments, the rows of sympodial bamboo plants are spaced at least 5 meters apart. In some embodiments, the rows of sympodial bamboo plants are spaced at least 6 meters apart. In some embodiments, the rows of sympodial bamboo plants are spaced at least 7 meters apart. In some embodiments, the rows of sympodial bamboo plants are spaced at least 8 meters apart. In some embodiments, the rows of sympodial bamboo plants are spaced at least 9 meters apart. In some embodiments, the rows of sympodial bamboo plants are spaced no more than 10 meters apart. In some embodiments, all the rows of sympodial bamboo plants in the plantation, forest, or stand are planted or grow the same or similar distances apart from each other. In some embodiments, all the rows of sympodial bamboo plants in the plantation, forest, or stand are planted or grow with a variable distance apart from each other.

In certain aspects, the inventions also relates to a bamboo plantation, bamboo forest, or bamboo stand comprising rows of sympodial bamboo plants, wherein bamboo clumps from non-adjacent strips of rows are harvested, wherein the non-adjacent strips are separated from each other by at least 2 strips and the strips are at least 1 to no more than 10 meters wide; and wherein the rows of sympodial bamboo plants are spaced at least 1 meter to no more than 10 meters apart. As described herein, the strips of rows can contain more than one row of sympodial bamboo plants

In certain aspects, the invention provides a method of harvesting a sympodial bamboo plantation, forest, or stand comprising: (a) dividing the sympodial bamboo plantation, forest, or stand into at least 1 meter wide strips; and (b) harvesting bamboo clumps within non-adjacent strips, wherein the non-adjacent strips are separated from each other by at least 2 strips. In some embodiments, the sympodial bamboo plantation, forest, or stand comprises sympodial bamboo plants planted or grown in rows at least 1 meter to no more than 10 meters apart.

In some embodiments, the strips are 1 to 10 meters wide. In some embodiments, the strips are at least 1 meter wide. In some embodiments, the strips are at least 2 meters wide. In some embodiments, the strips are at least 3 meters wide. In some embodiments, the strips are at least 4 meters wide. In some embodiments, the strips are at least 5 meters wide. In some embodiments, the strips are at least 6 meters wide. In some embodiments, the strips are at least 7 meters wide. In some embodiments, the strips are at least 8 meters wide. In some embodiments, the strips are at least 9 meters wide. In some embodiments, the strips are no more than 10 meters wide. In some embodiments, all the strips are the same width. In some embodiments, the strips are different widths.

In some embodiments, the strips are about 1 meter wide. In some embodiments, the strips are about 2 meters wide. In some embodiments, the strips are about 3 meters wide. In some embodiments, the strips are about 4 meters wide. In some embodiments, the strips are about 5 meters wide. In some embodiments, the strips are about 6 meters wide. In some embodiments, the strips are about 7 meters wide. In some embodiments, the strips are about 8 meters wide. In some embodiments, the strips are about 9 meters wide. In some embodiments, the strips are about 10 meters wide.

In some embodiments, the non-adjacent strips are separated from each other by at least 3 strips. In some embodiments, the non-adjacent strips are separated from each other by at least 4 strips. In some embodiments, the non-adjacent strips are separated from each other by 2 strips. In some embodiments, the non-adjacent strips are separated from each other by 3 strips. In some embodiments, the non-adjacent strips are separated from each other by 4 strips.

In some embodiments, the bamboo clumps within non-adjacent strips are harvested once every 3 to 5 years. Therefore, in some embodiments, one third to one fifth of the plantation, forest, or stand is harvested every year. In some embodiments, the bamboo clumps within non-adjacent strips are harvested once every 3 years. In some embodiments, the bamboo clumps within non-adjacent strips are harvested once every 4 years. In some embodiments, the bamboo clumps within non-adjacent strips are harvested once every 5 years.

In some embodiments, the non-adjacent strips of rows of sympodial bamboo plants are harvested as described herein for monopodial bamboo plantations, forests, and stands.

The strip or row harvesting described herein, can be used to harvest the bamboo clumps of a bamboo plantation or to harvest bamboo clumps of a naturally occurring bamboo forest, or bamboo stand. In some embodiments, sympodial bamboo plants growing in naturally occurring bamboo forests or stands does not grow in defined rows. These forests or stands can be marked or divided into strips as described for monopodial bamboo plantations, forests and stands and harvested as described herein so that bamboo clumps within 1 to 10 meter wide non-adjacent strips are harvested.

In some embodiments, bamboo clumps of the plantation, forest, or stand are harvested mechanically. For example, the bamboo clumps can be harvested with a chain saw. Bamboo can also be cut mechanically with a bamboo cutting machine that cuts the plant at the base of the culm and loads the cut bamboo onto a carrier. In some embodiments, bamboo clumps of the plantation, forest, or stand are harvested non-mechanically. For example, the bamboo clumps are harvested with a machete or a bush knife between the first and second node from the ground. In some embodiments, all bamboo clumps within the non-adjacent rows or strips are harvested. Completely clearing a row of bamboo allows for ease of removal of harvested material from the plantation, forest, or stand area.

In some embodiments, the sympodial bamboo plants are planted at a density of at least 150 plants per hectare. In some embodiments, the sympodial bamboo plants are planted at a density of at least 250 plants per hectare. In some embodiments, the sympodial bamboo plants are planted at a density of at least 350 plants per hectare. In some embodiments, the sympodial bamboo plants are planted at a density of at least 450 plants per hectare. In some embodiments, the sympodial bamboo plants are planted at a density of at least 550 plants per hectare. In some embodiments, the sympodial bamboo plants are planted at a density of at least 650 plants per hectare. In some embodiments, the sympodial bamboo plants are planted at a density of at least 750 plants per hectare. In some embodiments, the sympodial bamboo plants are planted at a density of at least 850 plants per hectare. In some embodiments, the sympodial bamboo plants are planted at a density of at least 950 plants per hectare. In some embodiments, the sympodial bamboo plants are planted at a density of at least 1000 plants per hectare.

In some embodiments, the sympodial bamboo plants are planted at a density of about 150 plants per hectare. In some embodiments, the sympodial bamboo plants are planted at a density of about 250 plants per hectare. In some embodiments, the sympodial bamboo plants are planted at a density of about 350 plants per hectare. In some embodiments, the sympodial bamboo plants are planted at a density of about 450 plants per hectare. In some embodiments, the sympodial bamboo plants are planted at a density of about 550 plants per hectare. In some embodiments, the sympodial bamboo plants are planted at a density of about 650 plants per hectare. In some embodiments, the sympodial bamboo plants are planted at a density of about 750 plants per hectare. In some embodiments, the sympodial bamboo plants are planted at a density of about 850 plants per hectare. In some embodiments, the sympodial bamboo plants are planted at a density of about 950 plants per hectare. In some embodiments, the sympodial bamboo plants are planted at a density of about 1000 plants per hectare.

In some embodiments, the sympodial bamboo plant belongs to the genus Bambusa sp., Cephalostachym sp., Chusquea sp., Dendrocalamus sp., Dinochloa sp., Fargesia sp., Gigantochloa sp., Guadua sp., Melocalamus sp., Oxytenanthera sp., Schizostachyum sp., Thamnocalamus sp., Thyrostachys sp., or Yushania sp. In some embodiments, the sympodial bamboo is Bambusa vulgaris, Bambusa balcooa, Bambusa blumeana, Bambusa polymorpha, Bambusa textilis, Cephalostachyum pergracile, Dendrocalamus asper, Dendrocalamus barbatus, Dendrocalamus giganteus, Dendrocalamus membranaceus cv grandis, Dendrocalamus strictus, Dendrocalamus sinicus, Guadua aculeata, Guadua amplexifolia, Guadua angustifolia, or Oxytenanthera abyssinica.

In certain aspects, the invention relates to a bamboo plantation grown from tissue culture plantlets, vegetative propagation, or from seed. In some embodiments, the bamboo plants are planted from seed, tissue culture plantlets or by vegetative means.

In some embodiments, the plantation, forest, or stand is farmed using conventional methods. In some embodiments, the bamboo plants are farmed using conventional methods, including but not limited to fertilization, weeding and pest control. In some embodiments, the bamboo plants are treated with fertilizer. In some embodiments, the bamboo plants are not treated with fertilizer.

Unless otherwise defined, all technical and scientific terms used herein have the same meaning as commonly understood by one of ordinary skill in the art to which this invention belongs. Exemplary methods and materials are described below, although methods and materials similar or equivalent to those described herein can also be used in the practice or testing of the present invention.

Those skilled in the art will recognize, or be able to ascertain, using no more than routine experimentation, numerous equivalents to the specific substances and procedures described herein. Such equivalents are considered to be within the scope of this invention, and are covered by the following claims.

All publications and other references mentioned herein are incorporated by reference in their entirety, as if each individual publication or reference were specifically and individually indicated to be incorporated by reference. Publications and references cited herein are not admitted to be prior art.

### EXAMPLES

Examples are provided below to facilitate a more complete understanding of the invention. The following examples illustrate the exemplary modes of making and practicing the invention. However, the scope of the invention is not limited to specific embodiments disclosed in these Examples, which are for purposes of illustration only, since alternative methods can be utilized to obtain similar results.

### Example 1

FIG. 8 shows a mature monopodial bamboo plantation in China where the monopodial bamboo has been divided into 3 meter wide strips, and wherein a 3 meter wide strip has undergone strip harvesting. All culms within this strip have been harvested.

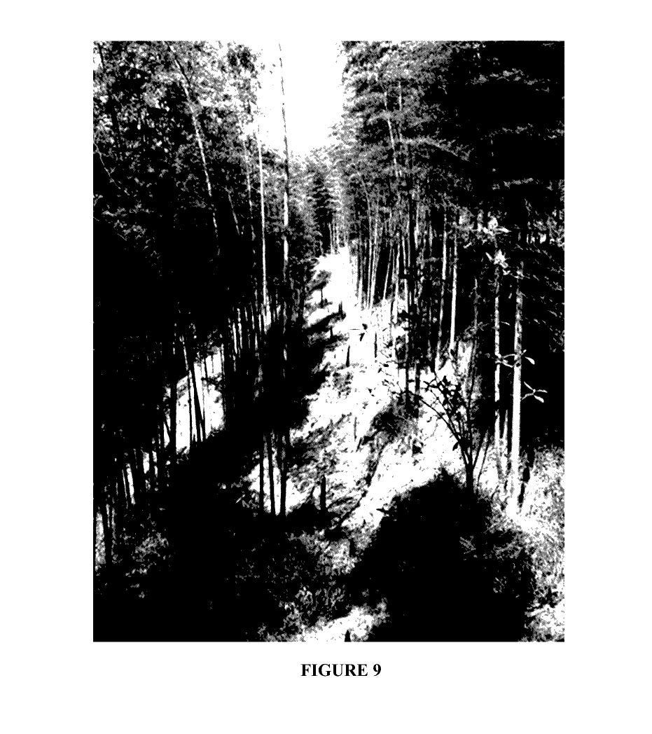

FIG. 9 shows the mature monopodial bamboo plantation in China where the harvested 3 meter wide strip from FIG. 8 has undergone a year of regrowth and at a time where a non-adjacent 3 meter wide strip will be harvested.

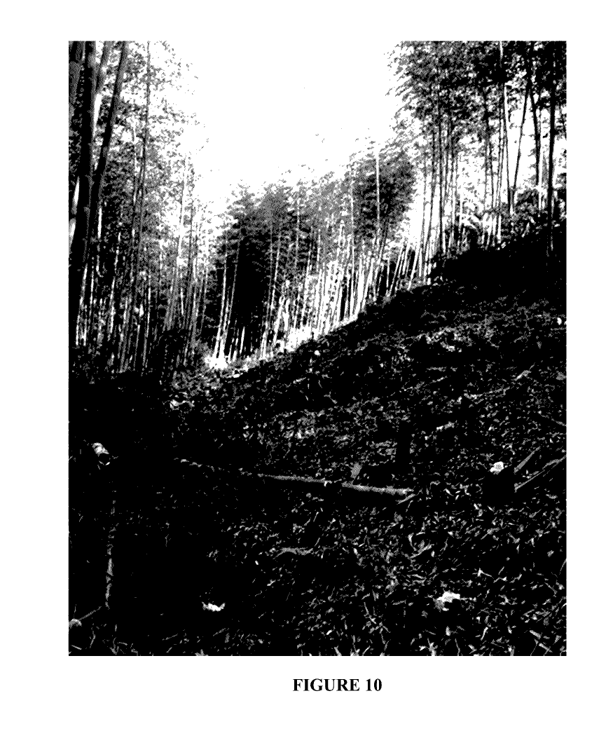

FIG. 10 shows a mature monopodial bamboo plantation in China where the monopodial bamboo has been divided into strips of 6 meters wide, and wherein a 6 meter wide strip has undergone strip harvesting. All culms within this strip have been harvested.

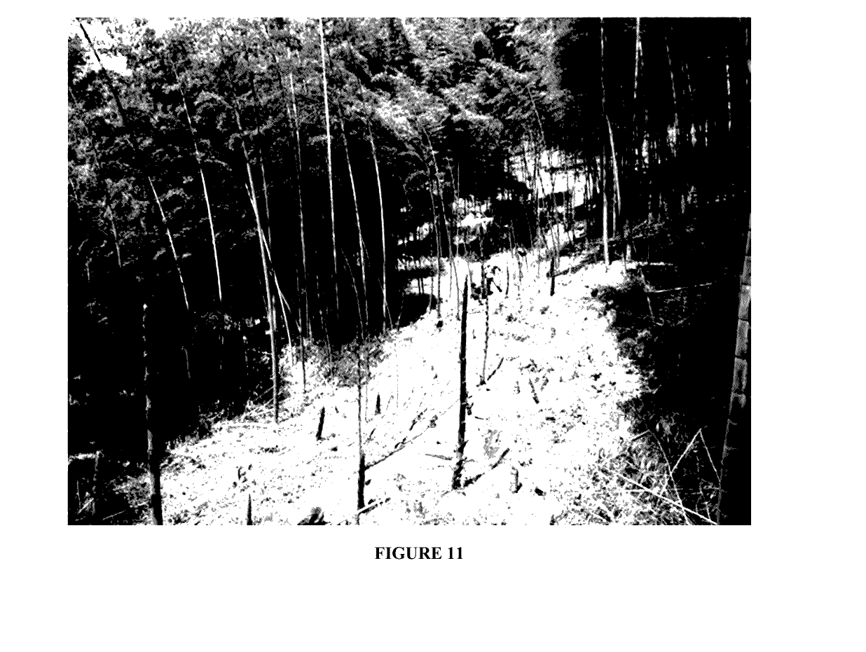

FIG. 11 shows a mature monopodial bamboo plantation in China where the monopodial bamboo has been divided into strips of 9 meters wide, and wherein a 9 meter wide strip has undergone strip harvesting. All culms within this strip have been harvested.

1. A bamboo plantation, forest, or stand comprising monopodial bamboo plants, wherein bamboo culms within non-adjacent strips are harvested, wherein the non-adjacent strips are separated from each other by at least 2 strips and the strips are at least 1 meter wide.

2. The plantation, forest, or stand of claim 1, wherein the non-adjacent strips are separated from each other by at least 3 strips.

3. The plantation, forest, or stand of claim 1, wherein the non-adjacent strips are separated from each other by at least 4 strips.

4. The plantation, forest, or stand of claim 1, wherein the non-adjacent strips are separated from each other by 2 strips.

5. The plantation, forest, or stand of claim 1, wherein the non-adjacent strips are separated from each other by 3 strips.

6. The plantation, forest, or stand of claim 1, wherein the non-adjacent strips are separated from each other by 4 strips.

7. The plantation, forest, or stand of claim 1, wherein the strips are 1 meter to 10 meters wide.

8. The plantation, forest, or stand of claim 1, wherein the bamboo culms are harvested mechanically.

9. The plantation, forest, or stand of claim 1, wherein the bamboo culms are harvested non-mechanically.

10. The plantation, forest, or stand of claim 1, wherein the monopodial bamboo plant belongs to the genus: Acidosasa sp., Arundinaria sp., Bashania sp., Chimonobambusa sp., Indocalamus sp., Pleioblastus sp., Phyllostachys sp., Sasa sp., Schizostachym sp., or Semiarundinaria sp.

11. The plantation, forest, or stand of claim 1, wherein the bamboo culms within non-adjacent strips are harvested once every 3 to 5 years.

12. The plantation, forest, or stand of claim 4, wherein the bamboo culms within non-adjacent strips are harvested once every 3 years.

13. The plantation, forest, or stand of claim 5, wherein the bamboo culms within non-adjacent strips are harvested once every 4 years.

14. The plantation, forest, or stand of claim 6, wherein the bamboo culms within non-adjacent strips are harvested once every 5 years.

15. The plantation, forest, or stand of claim 1, wherein all bamboo culms within the non-adjacent strips are harvested.

16. A method of harvesting monopodial bamboo plants, the method comprising harvesting bamboo culms from within non-adjacent strips wherein the non-adjacent strips are separated from each other by at least 2 strips and the strips are at least 1 meter wide.

17. A method of harvesting a monopodial bamboo plantation, forest, or stand, comprising:
a) dividing the monopodial bamboo plantation, forest, or stand into at least 1 meter wide strips; and
b) harvesting bamboo culms within non-adjacent strips, wherein the non-adjacent strips are separated from each other by at least 2 strips.

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. A bamboo plantation, forest, or stand, comprising rows of sympodial bamboo plants, wherein bamboo clumps from non-adjacent rows are harvested, wherein the non-adjacent rows are separated from each other by at least 2 rows.

33. A bamboo plantation, forest, or stand comprising rows of sympodial bamboo plants, wherein bamboo clumps from non-adjacent strips of rows are harvested, wherein the non-adjacent strips are separated from each other by at least 2 strips and the strips are at least 1 to no more than 10 meters wide; and wherein the rows of sympodial bamboo plants are spaced at least 1 meter to no more than 10 meters apart.

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. A method of harvesting sympodial bamboo, the method comprising harvesting bamboo clumps from non-adjacent rows of sympodial bamboo plants, wherein the non-adjacent rows are separated from each other by at least 2 rows.

57. A method of harvesting a sympodial bamboo plantation, forest, or stand comprising:
a) dividing the sympodial bamboo plantation, forest, or stand into at least 1 meter wide strips; and
b) harvesting bamboo clumps within non-adjacent strips, wherein the non-adjacent strips are separated from each other by at least 2 strips.

58. (canceled)

59. (canceled)

60. (canceled)

61. (canceled)

62. (canceled)

63. (canceled)

64. (canceled)

65. (canceled)

66. (canceled)

67. (canceled)

68. (canceled)

69. (canceled)

70. (canceled)

71. (canceled)

72. (canceled)

73. (canceled)

74. (canceled)

75. (canceled)

76. (canceled)

77. (canceled)

78. (canceled)

79. (canceled)
